(19) United States
(12) Patent Application Publication
(10) Pub. No.: US 2014/0208369 A1
(43) Pub. Date: Jul. 24, 2014

(54) APPARATUS AND SYSTEM FOR PERSONAL DISPLAY OF CABLE AND SATELLITE CONTENT

(71) Applicant: Steve Holmgren, Santa Barbara, CA (US)

(72) Inventor: Steve Holmgren, Santa Barbara, CA (US)

(21) Appl. No.: 13/861,310

(22) Filed: Apr. 11, 2013

Related U.S. Application Data
(60) Provisional application No. 61/754,538, filed on Jan. 19, 2013.

(51) Int. Cl. H04N 21/41; H04N 21/61

(52) U.S. Cl. CPC H04N 21/4113; H04N 21/6143
USPC 725/68; 725/133

(57) ABSTRACT

A set top terminal is configured to be accessible to a content management tool over a local network. The set top terminal includes means for delivering remote content from a cable or satellite content provider to a television screen in a form that is readily viewable on the television screen and means for storing the remote content for delayed viewing. The set top terminal also includes means for transcoding the remote content to a form that the content management tool is configured to utilize, where the form that the content management tool is configured to utilize is different than the form that is readily viewable on the television screen. The set top terminal can be part of a network including a personal display device and a content management tool. The content management tool may be embedded within the personal display device.

### CROSS-REFERENCE TO RELATED APPLICATIONS

This application claims the benefit and priority of U.S. Provisional Application Ser. No. 61/754,538, filed on Feb. 5, 2013 and titled “APPARATUS AND SYSTEM FOR PERSONAL DISPLAY OF CABLE AND SATELLITE CONTENT”, the entire contents of which are hereby incorporated by reference for all purposes.

### TECHNICAL FIELD

This invention relates to devices and methods utilized for the processing and distribution of cable and satellite set top content.

### BACKGROUND

Cable and satellite entertainment systems contain in-home terminals, known as set top boxes. Set top boxes implement content access control, recording, display device interfacing, and other functions. While recorded set top box content is widely available, recorded set top content viewing opportunities are generally limited to locally tethered TV style systems with large multi-megapixel displays and powerful audio systems.

Set top terminals such as set top boxes are available from cable and satellite service providers or, with the use of a cable/satellite provider content access security card, can be purchased from third party vendors. Content access security implemented via the interfacing of the set top box with the content access security card includes a means by which a cable or satellite content provider can uniquely identify the user/subscriber in order to customize the content delivered to the user/subscriber.

Additionally, some television makers have begun including set top terminals/components and their associated functionality directly within their television offerings. That is, televisions are being manufactured with set top terminals integrated directly into the television sets. Components in set top terminals can include one or more cable/satellite channel tuners, a processor, memory, bulk storage, and firmware programming to implement set top functionality.

In order for smart phones, tablets, and other personal devices to access and display normal content, they are tethered to a local computer implemented tool for content update and management. Using a graphical computer interface, this content management tool is directed to retrieve remote content and downloads (“syncs”) selected content to a personal device.

FIG. 1 shows an illustrative environment where an example of a personal device tablet 10 and smart phone 12 are tethered to a computer-based tool 14, which includes a built in content management tool 16, implementing personal device content management. Content management tools 16 generally have configurations for display and management of previously downloaded data, the browsing of potential new content for download via web syndication, or the automatic download of episodic classes of audio, video, or other content containing daily or semi-regularly updated versions of the content.

Content on personal devices 10 and 12 is downloaded (“synced”) from the content management tool 16 and can include music, videos, and alternative podcast content. Other personal devices managed in this fashion include media players normally used for personal storage and playback of music and music videos. The computer-based tool 14 and content management tool 16 are in turn interfaced with remote content source(s) 18 containing audio or video data for potential download.

The term podcast is commonly associated with the subscription and delivery of pre-produced content for replay by the user at a later date. It relates to a mechanism by which audio or video files are stored upon a delivery server 18 (see FIG. 1) and advertised for download. The downloaded podcast is typically stored on local disk storage of the computer-based tool 14. When instructed by a local user, the content management tool 16 downloads video, audio and other associated podcast content to personal device storage 10 and 12. Personal devices 10 or 12 may be removed from their tether to the computer-based tool 14 and used as standalone devices, where previously downloaded podcast content may be “played” on the display and audio system of the personal device for the enjoyment of the user. Changes to the remote content on the delivery server 18 can be monitored by the content management tool 16, which will attempt to (re)-download modified podcasts.

### SUMMARY

In a first aspect, a network is described. The network includes a personal display device, a computer-based content management tool, a television set, and a set top terminal locally tethered to the television set. The set top terminal is accessible to the computer-based content management tool over the network and is configured to store viewable content in a first format for delayed use. Furthermore, the television set is configured to display the content in the first format, and the set top terminal includes a set top extension comprising a means for implementing remote content source management and a means for compressing the viewable content into a second format.

In a second aspect, a network is described. The network includes a personal display device, a content management tool embedded within the personal display device, a television set, and a set top terminal locally tethered to the television set. The set top terminal is accessible to the computer-based content management tool over the network and is configured to store audible or viewable content for delayed use. Furthermore, the set top terminal includes a set top extension comprising one or more modules configured to implement remote content source management and compression of the audible or viewable content.

Networks described herein may include one or more of the following features. The network can be a local area network. The computer-based content management tool can be embedded within the personal display device. The set top extension can be configured to implement at least one of MPEG-4 video compression, H.264 video compression, MP3 audio compression, and AAC-LC audio compression. The set top extension can be configured to implement XML or RSS 2.0 as a content syndication vehicle. The set top extension can be configured to provide for content transcoding specific to the personal display device. The personal display device can be a phone or a table computer. The set top extension can be configured to parameterize device transcoding with RESTful URL encoding. The set top extension can be configured to automatically publish recorded content for browsing and syndication by the personal display device using RSS 2.0 syndication. The personal display device and the computer-based content management tool can be provided as a single electronic device.

The audible or viewable content can be stored on the set top terminal in a first format, and the personal display device can be configured to utilize content of a second format, the second format being different from the first format. The second format can be of lower resolution or smaller physical memory size than the first format. At least one of the one or more modules can be configured to compress the audible or viewable content from the first format to the second format. The content management tool can be configured to issue a content request to the set top terminal, and the set top terminal can be configured to issue a reply directly to the content management tool.

In a third aspect, a set top terminal is described. The set top terminal is configured to be accessible to a content management tool over a local network. The set top terminal further comprises means for delivering remote content from a cable or satellite content provider to a television screen in a form that is readily viewable on the television screen, means for storing the remote content for delayed viewing, means for enabling the cable or satellite content provider to uniquely identify a subscriber, allowing the cable or satellite content provider to customize the content available to the subscriber, and means for transcoding the remote content to a form that the content management tool is configured to utilize. Additionally, the form that the content management tool is configured to utilize is different than the form that is readily viewable on the television screen.

Set top terminals described herein can also include the following feature. The content management tool to which the set top terminal is accessible is embedded within a personal display device, and the form that the content management tool is configured to utilize is a form that is optimized for the personal display device.

In a fourth aspect, a method of delivering content from a content server to a personal device is described. The method includes entering a URL into a local content management tool, the URL referencing an RSS file available on the content server, adding device specific characteristics of the personal device to the URL, and downloading the RSS file. The method further includes having the content management tool request the content, having the content server transcode the content according to the device specific characteristics added to the URL, and downloading the transcoded content from the content server.

Methods described herein may also include one or more of the following features. The method can further include pushing the content to the personal device. The adding of the device specific characteristics can be performed by the content management tool. The content management tool can be embedded within the personal device, and downloading the transcoded content from the content server can include downloading the transcoded content directly to the personal device. Adding device specific characteristics of the personal device to the URL can include including Representation State Transfer (RESTFul) within the URL.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is an illustrative diagram of a network of the prior art which includes one or more personal devices, a computer-based tool which includes a content management tool, and a delivery server providing remote content.

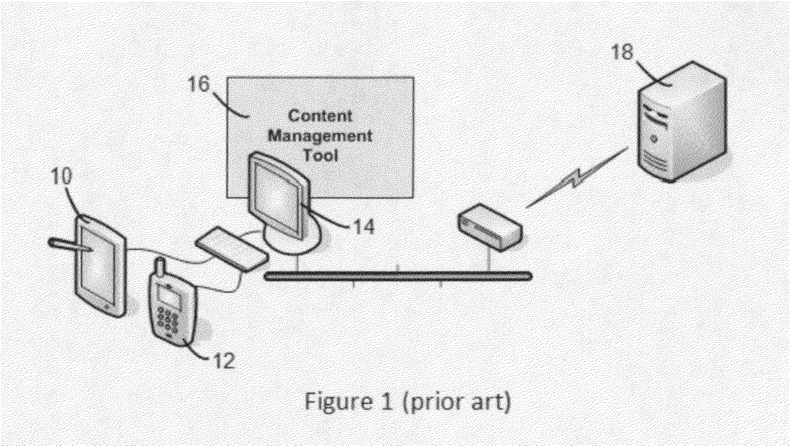

FIG. 2A is an illustrative diagram of a network including one or more personal devices, a computer-based tool which includes a content management tool, and a set top terminal with extended functionality.

FIG. 2B is a schematic diagram of the set top terminal of FIG. 2A.

FIGS. 3A and 3B are the XML text of a sample podcast.

FIG. 4 is a schematic diagram of another set top terminal with extended functionality.

FIG. 5A is an illustrative diagram of a network including one or more personal devices, a computer-based tool which includes a content management tool, and the set top terminal of FIG. 4.

FIG. 5B is an illustrative diagram of a network including one or more personal devices each including a content management tool embedded within the device and the set top terminal of FIG. 4.

FIG. 6 is a diagram depicting a method of pushing content to a personal device from a content source.

Like reference symbols in the various drawings indicate like elements.

### DETAILED DESCRIPTION

Described herein are devices and methods which create the seamless merger of recorded set top content with personal displays such as tablets, smart phones, and other video and audio playback tools (e.g., an Apple iPod). The devices and methods described include set top terminals with extensions necessary for the set top terminal to serve as a personal display content source. Implementations of set top terminal extensions and associated functionality include automatic podcast syndication for newly recorded set top content and the transcoding of multi-mega pixel TV style video and audio for smaller, less powerful personal devices. These extensions promote content appreciation by reducing difficulty in display of set top content on personal display devices, and can broadly expand content viewing opportunities from locally tethered TV style devices to include the private distribution to smart phones, tablets, and other personal display devices.

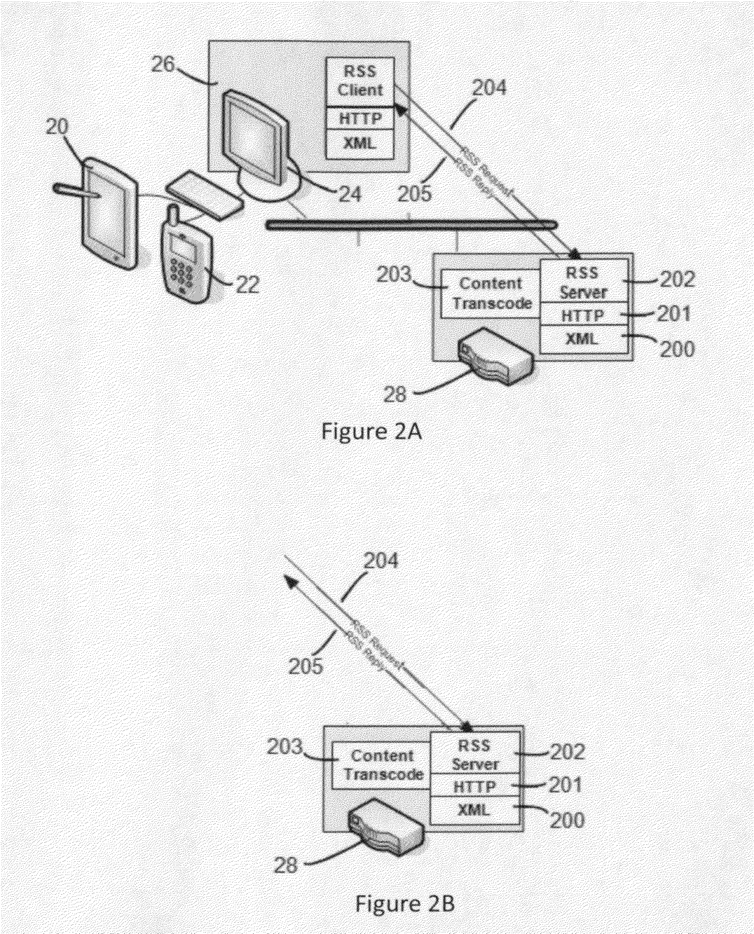

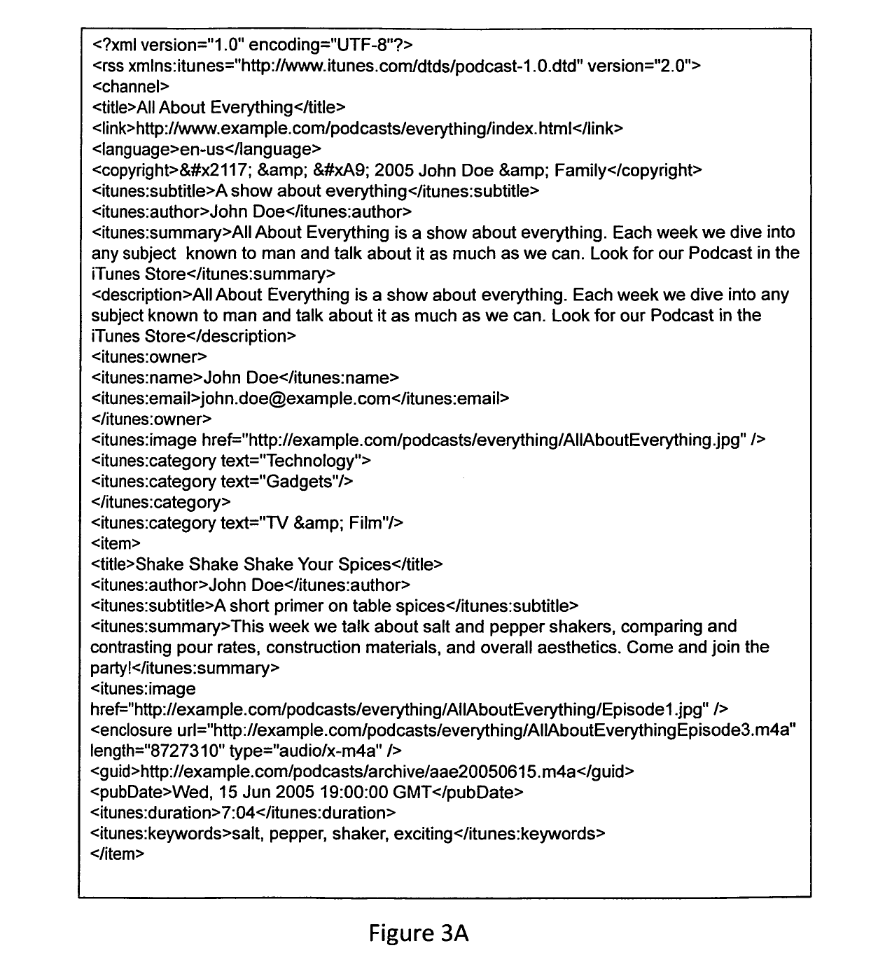

Referring to FIG. 2A, according to one implementation of the invention, set top terminal functionality is extended so that it provides for the browsing, automatic podcast syndication, content transcoding, and episodic download of set top cable or satellite content (i.e., prerecorded content stored on the set top terminal which was supplied by the cable or satellite provider). That is, in addition to the conventional set top components (one or more cable/satellite channel tuners, a processor, memory, bulk storage, firmware programming to implement set top functionality, means for interfacing of the set top terminal with a content access security card for implementing content access security etc.) and capabilities of delivering customized content from a cable or satellite provider to a locally tethered television device, the set top terminal includes additional hardware and/or modifications to existing hardware that allow content stored on or accessed through the set top terminal to be displayed or broadcast on a personal display device.

FIG. 2A depicts a set top terminal 28 operating as a personal device content source, in addition to providing conventional set top functionality described above. In FIG. 2, a local user and content management tool 26 interact with a user interface providing for the browsing, selection, and download of set top content to personal devices 20 and 22. Personal devices 20 and 22 are typically handheld devices such as phones, tablets (e.g., an Apple iPad), or handheld media players (e.g., an Apple iPod), but may be other types of portable devices as well. The content management tool 26 and set top terminal 28 interact formally using web-based client/server exchange to retrieve content source listings and syndicated content described by RSS 2.0 files. In the exchange illustrated in FIG. 2, the content management tool 26 is instructed to download the RSS 2.0 information for a content file. The content management tool 26 issues an RSS Request 204 to the set top terminal 28. The set top terminal 28 processes the request and returns an RSS 2.0 file via an RSS Reply transfer 205.

Referring to FIG. 2B, the set top terminal 28 shown in FIG. 2A, which includes components such as one or more cable/satellite channel tuners, a processor, memory, bulk storage, means for interfacing of the set top terminal with a content access security card for implementing content access security, and firmware programming to implement set top functionality, has been extended to also include an interne server capable of:
1. supporting generalized listing of recorded content and recording schedule 200,
2. automatic detection and syndication of newly recorded set top content,
3. (re)formatting selected content in a compressed form via content transcode means 203, and
4. compressed content transport to a personal device content manager on demand via HTTP 201.

As shown in FIG. 2B, the set top terminal extension includes a network server capable of responding to Extensible Markup Language (XML) 200 style content requests for recorded content and for recording schedule. XML is used to express arbitrary lists and names in a machine independent manner. XML is also commonly used as the underlying framework for Hyper Text Transfer Protocol (HTTP) 201 used in ordinary web browsers and servers. Having extended a set top terminal with XML and an HTTP server provides the foundation for a content management tool portal to examine available podcast content. When a podcast is selected for download, HTTP request and reply traffic to RSS 2.0 server 202 provides for the download of a podcast RSS 2.0 specification to the content management tool 26 illustrated in FIG. 2A.

A dialect of XML known as RSS 2.0 is a web content syndication vehicle with URL locators for the audio and video elements of a podcast. It also contains XML tags describing podcast title, copyright, language, publication date, and a host of other meta information. All of this information is bound into a syndicated description of the personal device content as a single text-based entity. It is the RSS 2.0 content of a podcast that is the first information downloaded by a content management tool, as previously described with reference to FIG. 2A.

Another feature included in the set top terminals described herein is a means 203 for the transcoding of cable and satellite content into form and presentation that standard content management tools 26 normally utilize. That is, cable and satellite content files delivered to and stored on a set top terminal are typically configured to be displayed or broadcast on TV style systems with large multi-megapixel displays and powerful audio systems. For example, recorded content stored on a set top component such as a set top box may typically be configured to be viewed by a television capable of displaying 1080p video content (i.e., high density or HD video displayed in a 1920×1080 pixel array, displayed at 24, 50, or 60 frames per second), or content of even higher resolution. Personal devices, and in particular handheld devices, are typically not configured for optimal viewing of content stored in this format, or in other formats that are common for set top content. A set top terminal 28 serving as a content source for personal devices therefore can include means 203 for transcoding of the recorded content into a form and presentation that the content management tool 26 can deliver to the personal devices 20 and 22 such that the content can be adequately displayed on the personal devices.

Referring again to FIGS. 2A and 2B, as previously described, after an RSS 2.0 request 204 is received by the set top terminal 28, the video or audio content associated with the request 204 may need to be transcoded before an RSS 2.0 reply 205 can be initiated. As part of the transcoding process, specific characteristics (e.g., supported video/audio file types, screen resolution, etc.) of the end personal device need to be factored into the video, audio, and other transcoding algorithms. One aspect of this invention includes the use of the RSS 2.0 content request URL elements to refine personal device transcoding characteristics. The use of Representation State Transfer (RESTFul) within an RSS 2.0 URL can be implemented to define device characteristics such as device type (e.g. iPhone5) or individual device characteristics such as pixel density or display aspect ratio. That is, as part of issuing the RSS 2.0 request 204, the content management tool 26 can extend the RSS 2.0 URL with RESTful URL parameters indicating one or more specific characteristics of the end personal device. Part of the REST process is to provide for the addition of key/value pair parameterizations as an extension of a URL. Each key value is a well known key such as PIXEL_PER_INCH. The value is designated by an “=” and a value. In this case “PIXEL_PER_INCH=300” might describe the pixel density of an end display. The URL containing a RESTful key/value pair would look like:

http://mylocal_settop/latest_news_channel4/?PIXEL_PER_INCH=300&
A URL-based device specification might look like:
http://mylocal.settop/latest_news_channel10/?DEVICETYPE=iPhone5&

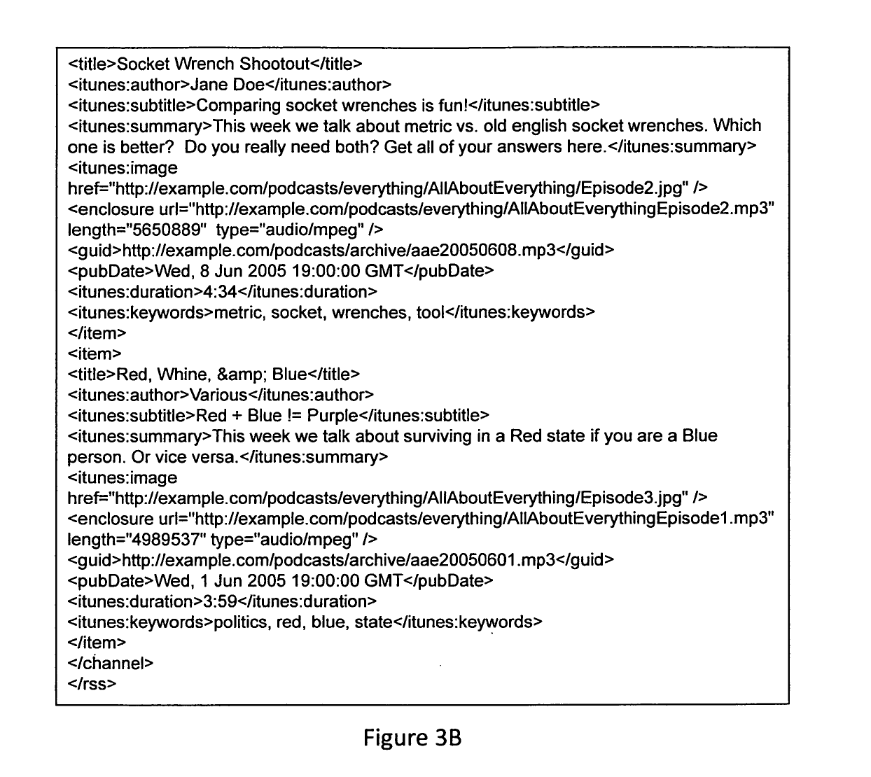

FIGS. 3A and 3B contain the XML text of an example podcast. In this example, the podcast contains three audio episodes of something for which the title is “All About Everything”, the language is US English, the author is John Doe, and the URL for episode 3 is http://example.com/podcasts/everything/AllAboutEverythingEpisode3.m4a length=872310 type=audio/x-m4a. The URL for episode 2 is http://example.com/podcasts/everything/AllAboutEverythingEpisode2.mp3 length=5650889 type=audio/mpeg. Various other characteristics such as publication date, keywords, and summary are included. Importantly, note that other than the audio types m4a and mp3, no information is contained about the audio quality, sample rate, or recording fidelity necessary to the end device playback quality.

Also described herein are the specifications of the content download URL extensions that provide end device capability specifications. Specifications such as display pixel density, aspect ratio, and audio playback capabilities are used by the content transcoder 203 to (re)format the content at download to the specific capabilities of the end device.

Uncompressed video formatted for TV style 1080p sized displays storing high definition video at 60 frames per seconds, which is one of the typical formats for set top terminal recorded content, requires 410 giga-bytes of data for one hour of recording. Eight channels of 24-bit audio requires 16 mega-bytes/sec or 7 giga-bytes for 1 hour of audio. Recorded video and audio can be compressed to make the transport and playback of any sizeable content tractable. There are various video and audio compression standards that substantially reduce the storage requirements for digital handling of content with only a modest decrease in fidelity. A problem then arises in that different podcasts are recorded with different recording standards. At the same time different personal display devices have different display and playback characteristics such as pixel density. There is a requirement then to process certain podcast content so that the video and audio recordings can be re-fitted to the characteristics of the personal display devices. The set top terminals described herein contain a set of encoding and decoding capabilities providing for the (re-)encoding of video and audio content into different content formats. Additionally, the set top terminals include means for modifying the recorded content designed to fit the recorded data to the characteristics of a personal device. These modifications include but are not limited to the decimation of pixels fitting a multi-megabyte video recording to a smaller personal device with a few tens of thousands of display pixels, as well as aspect ratio modification from high definition 16×9 formatted displays to more common 4×3 personal device video formats. In the audio realm, the audio quality of set top terminal recorded content is usually much more sophisticated than can be played on the physical audio outputs of a personal device. Therefore, the set top terminals herein can further include capabilities to reduce the audio encoding sample rate and size in post-processed audio content.

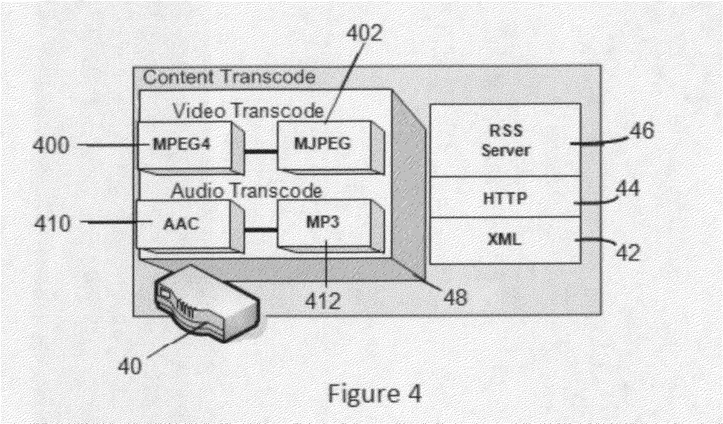

FIG. 4 depicts a set top terminal 40 which is similar to that of FIG. 2B but is further extended with MPEG4 and MJPEG video transcoding and AAC and MP3 audio transcoding. In FIG. 4, the set top terminal 40 is extended with transcoding capabilities 48. As previously described, transcode is the process of (re)formatting audio and video content from one compression format to another (e.g. MJPEG 402 to MPEG4 400). Alternatively, transcoding is the process of re-formatting an existing compressed audio or video file with different characteristics such as audio quality or video aspect ratio. MP3 is one of a family of audio compression tools used to minimize network overhead in the transport of digitized audio. MPEG4 is one of a family of video compression tools used to minimize network overhead in the transport of video images.

MP3 compression (412) removes duplicate bit patterns and, using psycho acoustics, eliminates less audible or meaningful sound from the compressed version. For example, a standard 640 mega-byte CD will hold 1 hour of uncompressed audio. The same CD will hold 7 hours of MP3 compressed audio. FIG. 4 also depicts a non-psycho acoustic, lossless alternative to MP3 called AAC-LC audio compression (410) used to create an Apple Inc. defined personal device content entity known as an Apple iTunes Podcast.

Video image compression eliminates duplicate or repeating sequences of image data. In addition, MPEG4 uses temporal motion compression where image frames are compared frame-by-frame and only inter-frame differences are included in the compressed image. Compressed video success then is harder to predict and varies with complexity and sequencing of the video frames.

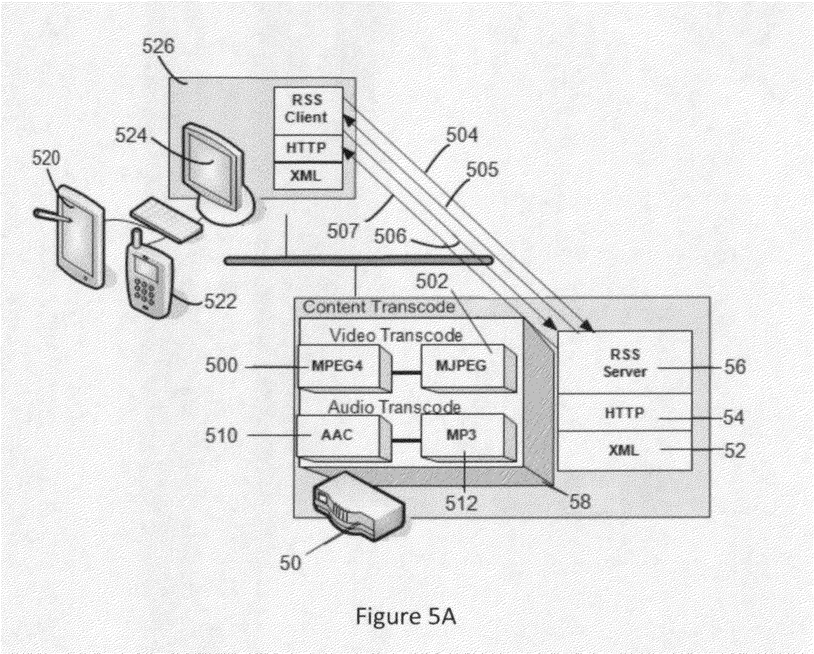

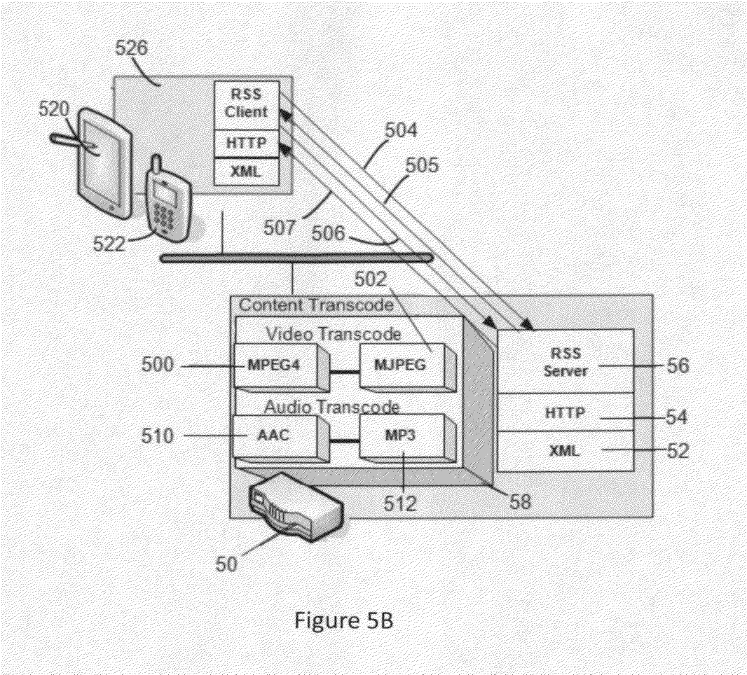

FIG. 5A depicts a network which includes a set top terminal 50 extended with support for recorded content/scheduling, MPEG-4 video compression 500, AAC-LC audio compression 510, and RSS 2.0 syndication 56. This set top terminal 50 is seamlessly interfaced to a personal display content management tool 526 as a content source, wherein the content management tool 526 is able to easily browse and download set top content, and push the content to one of the personal display devices 520 and 522 in the network in a format that is optimized for the personal display device.

In an alternative implementation, shown in FIG. 5B, the content management tool 526 is embedded within the personal display devices. The personal devices 520 and 522 each contain the processing and memory to issue RSS requests 504 to and process RSS replies 505 from a set top terminal 50. The resulting interaction with the RSS (56), HTTP (54), and XML (52) servers, which were described above, are carried on directly with the personal devices 520 and 522.

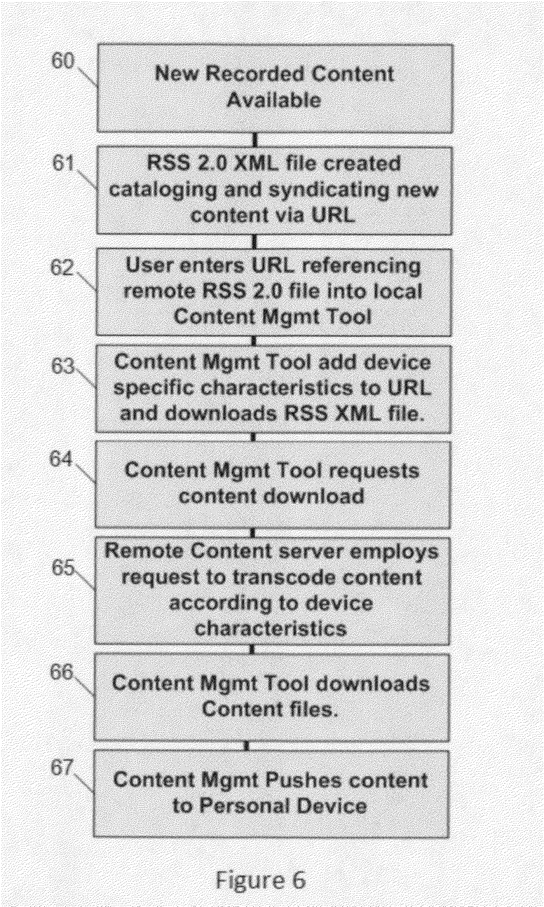

The processes, sequences or steps, and features discussed above are related to each other. The disclosed processes and sequences may be performed alone or in any combination to provide a system or a portion of a system. FIG. 6 shows the steps executed in an extended set top box (or alternatively another network contented source) such as that described herein to perform the syndication, transcoding, and downloading of recorded content.

Content publishers advertise a list of URLs 61 describing the content available for download. The content may be syndicated by the automatic review of newly recorded set top content and an RSS 2.0 XML automatically created (step 61) when the recorded content is available (step 60). The content source, which for example can be any of the set top terminals shown in FIGS. 2A, 2B, 4, 5A, and 5B, along with the other components in the network, then execute the following steps shown in FIG. 6 in order to publish content from the content source onto the personal display device.

The personal device content management tool, which may be associated with or imbedded within a computer-based personal device (as in FIG. 5B), or alternatively may be associated with or embedded within a separate computer-based tool, enters a syndicated URL (step 62) referencing an RSS 2.0 file on the content source. The content management tool then initiates an RSS 2.0 request (step 63), followed by a content request (step 64), to download the RSS 2.0 syndication file and associated content. Note that in step 63, the content manager can extend the RSS 2.0 URL with REST-based URL additions describing the local personal device and its characteristics. The set top content manager then uses the RESTFul information in the URL to parameterize the transcoding of the content and produce an RSS 2.0 podcast with URLs for the audio and video content suitably transcoded for the end device (step 65). The content management tool then downloads the content data (step 66). Later, the content management tool pushes the content to a remote personal device (step 67). In cases where the content management tool is embedded within the personal display device, the content data is downloaded directly to the personal display device, so step 67 is not needed.

A number of implementations have been described. Nevertheless, it will be understood that various modifications may be made without departing from the spirit and scope of the techniques and devices described herein. Accordingly, other implementations are within the scope of the following claims.

1. An assembly, consisting essentially of:
a television set configured to display viewable content that is stored in a first format;
a personal display device configured to display the viewable content after it is compressed into a second format, the personal display device having a computer-based content management tool embedded within; and
a set top terminal locally tethered to the television set, the set top terminal being accessible to the computer-based content management tool over a network, the set top terminal configured to store the viewable content in the first format for delayed use; wherein
the computer-based content management tool is configured to issue content requests directly to the set top terminal,
the set top terminal comprises means for implementing remote content source management for responding to the content requests and a means for compressing the viewable content from the first format into the second format, and
the personal display device is configured to download the viewable content directly from the set top terminal over the network after the viewable content is compressed into the second format.

2. The assembly of claim 1, wherein the network is a local area network.

3. (canceled)

4. The assembly of claim 1, wherein the set top terminal is configured to implement at least one of MPEG-4 video compression, H.264 video compression, MP3 audio compression, and AAC-LC audio compression.

5. The assembly of claim 1, wherein the set top terminal is configured to implement XML or RSS 2.0 as a content syndication vehicle.

6. The assembly of claim 1, wherein the set top terminal is configured to provide for content transcoding specific to the personal display device.

7. The assembly of claim 6, wherein the personal display device is a phone or a table computer.

8. The assembly of claim 1, wherein the set top terminal is configured to parameterize device transcoding with RESTful URL encoding.

9. The assembly of claim 1, wherein the set top terminal is configured to automatically publish recorded content for browsing and syndication by the personal display device using RSS 2.0 syndication.

10. The assembly of claim 1, wherein the personal display device and the computer-based content management tool are provided as a single electronic device.

11. An assembly, consisting essentially of:
a personal device;
a content management tool embedded within the personal device;
a television set; and
a set top terminal locally tethered to the television set, the set top terminal being accessible to the content management tool over a network, the set top terminal configured to store audible or viewable content in a first format for delayed use; wherein
the content management tool is configured to allow the personal device to issue content requests directly to the set top terminal,
the set top terminal comprises one or more modules configured to implement remote content source management for responding to the content requests and compression of the audible or viewable content to a second format, and
the content management tool is configured to allow the personal display device to download the audible or viewable content directly from the set top terminal over the network after the audible or viewable content is compressed into the second format.

12. The assembly of claim 11, wherein the audible or viewable content is stored on the set top terminal in the first format, and the personal display device is configured to utilize content of the second format, the second format being different from the first format.

13. The assembly of claim 12, wherein the second format is of lower resolution or smaller physical memory size than the first format.

14. The assembly of claim 13, wherein at least one of the one or more modules is configured to compress the audible or viewable content from the first format to the second format.

15. The assembly of claim 11, wherein the set top terminal is configured to issue a reply directly to the content management tool in response to the content request.

16. (canceled)

17. (canceled)

18. A method of delivering content from a content server directly to a personal device, the method comprising:
entering a URL into a local content management tool which is embedded within the personal device, the URL referencing an RSS file available on the content server;
adding device specific characteristics of the personal device to the URL and downloading the RSS file;
having the content management tool request the content;
having the content server transcode the content according to the device specific characteristics added to the URL; and
downloading the transcoded content from the content server directly to the personal device.

19. (canceled)

20. The method of claim 18, wherein the adding of the device specific characteristics is performed by the local content management tool.

21. (canceled)

22. The method of claim 18, wherein adding device specific characteristics of the personal device to the URL comprises including Representation State Transfer (RESTFul) within the URL.

23. The assembly of claim 11, wherein the content management tool is configured to be interfaced directly with a local user.

24. The assembly of claim 1, further comprising a server which is internal to the set top terminal, the server being configured to perform the compressing of the viewable content from the first format into the second format.
